(19) United States
(12) Patent Application Publication
(10) Pub. No.: US 2024/0104524 A1
(43) Pub. Date: Mar. 28, 2024

(54) METHODS AND SYSTEMS FOR PRE-VERIFICATION OF CRYPTOCURRENCY TRANSACTIONS ON BLOCKCHAIN NETWORKS

(71) Applicant: PreSend LLC, Casper, WY (US)

(72) Inventors: Lawrence E. Holisky, JR., Salem, OH (US); JoseCarlos Azua, Seattle, WA (US)

(21) Appl. No.: 18/527,952

(22) Filed: Dec. 4, 2023

Related U.S. Application Data
(63) Continuation of application No. PCT/US2023/016285, filed on Mar. 24, 2023.
(60) Provisional application No. 63/355,584, filed on Jun. 25, 2022.

(51) Int. Cl. G06Q 20/06; G06Q 20/36

(52) U.S. Cl. CPC G06Q 20/065; G06Q 20/36

(57) ABSTRACT

Methods, non-transitory computer-readable media, and verification servers are disclosed that facilitate cryptocurrency transaction pre-verification. In some examples, transaction data for a proposed cryptocurrency transaction is received. The transaction data includes a destination cryptocurrency wallet type, a blockchain network, and a first token contract address retrieved via a source cryptocurrency wallet. Network data including blockchain network(s) supported by the destination cryptocurrency wallet type and address data including a second token contract address for each of one or more tokens supported on each of the blockchain network(s) is then obtained. A determination is made whether the proposed cryptocurrency transaction is verified based on a comparison of portion(s) of the transaction data to the network data and the address data. A positive or negative result is sent to a client device or the source cryptocurrency wallet in response to the transaction data when the proposed cryptocurrency transaction is verified or unverified, respectively.

This application claims priority to U.S. Provisional Patent Application No. 63/355,584, filed Jun. 25, 2022, which is incorporated herein by reference in its entirety.

### TECHNICAL FIELD

This technology generally relates to cryptocurrencies and blockchain networks and, more particularly, to verification of prospective cryptocurrency transactions to be conducted within blockchain networks.

### BACKGROUND

It is estimated that tens of billions of dollars worth of cryptocurrency has been lost since the advent of blockchain technology. Many of these coins or tokens have been lost due to human error after cryptocurrency users misplaced their wallets or wallet keys. Other coins or tokens have been lost when sent from one cryptocurrency blockchain network to another cryptocurrency blockchain network. For example, a sender may attempt to send Binance coins or BNB tokens to a destination wallet hosted on the Coinbase centralized cryptocurrency exchange. While both Binance and Coinbase centralized cryptocurrency exchanges are Ethereum Virtual Machine (EVM) compatible, Coinbase does not accept BNB tokens in Coinbase exchange accounts, or Coinbase exchange custodial wallets, in which Coinbase holds the associated private keys, but does accept BNB tokens in Coinbase non-custodial wallets. Thus, even though Coinbase supports the Binance Evolution Proposal (BEP-20) blockchain network and Ethereum (ETH) blockchain networks with which BNB tokens are also compatible, deposits of BNB tokens sent into a Coinbase exchange custodial wallets on those blockchain networks, for example, will not be credited and the associated funds will simply be lost.

There are two common methods used to recover lost cryptocurrency coins or tokens. One method is to extract data from hard drives. Data recovery software can help in the process, and there are companies that utilize more advanced techniques, but they are quite expensive. Crypto-hunter services are another approach to recovering lost or stolen keys. Crypto-hunter services generally rely on massive processing power to brute-force the right key combination to a wallet. Crypto-hunter service firms usually require users to remember part of the lost keys, which may not be possible. Thus, a problem that exists only in blockchain computer networks is that cryptocurrency coins or tokens are susceptible to being lost and recovery of lost cryptocurrency coins or tokens is challenging and not available to the average user or cryptocurrency owner.

### SUMMARY

In one example, a method for cryptocurrency transaction pre-verification is disclosed that includes receiving transaction data for a proposed cryptocurrency transaction from a client device. The transaction data includes a destination cryptocurrency wallet type, a blockchain network, and a first token contract address retrieved via a source cryptocurrency wallet at the client device. Network data including blockchain network(s) supported by the destination cryptocurrency wallet type and address data including a second token contract address for each of one or more tokens supported on each of the blockchain network(s) is then obtained. A determination is made whether the proposed cryptocurrency transaction is verified based on a comparison of portion(s) of the transaction data to the network data and the address data. A positive result is sent to the client device or the source cryptocurrency wallet in response to the transaction data when the proposed cryptocurrency transaction is verified and safe to send. Additionally, a negative result is sent to the client device or the source cryptocurrency wallet in response to the transaction data, when the determination indicates the proposed cryptocurrency transaction is unverified, indicating that proceeding with the proposed transaction would be unsafe and result in loss of the associated tokens.

In another example, a non-transitory computer-readable medium is disclosed that includes instructions for cryptocurrency transaction pre-verification including executable code that, when executed by processor(s), causes the processor(s) to populate a database with network data and address data provided by an entity associated with a destination cryptocurrency wallet type. The network data includes blockchain network(s) supported by the destination cryptocurrency wallet type and the address data includes a first token contract address for each of one or more tokens supported on each of the blockchain network(s). Transaction data for a proposed cryptocurrency transaction is then received. The transaction data includes the destination cryptocurrency wallet type, a blockchain network, and a second token contract address. The network data and the address data are obtained from the database using the destination cryptocurrency wallet type. A determination is made whether the proposed cryptocurrency transaction is verified based on a comparison of the blockchain network to the one or more blockchain networks in the obtained network data and the second token contract address to the first token contract address. A negative result is sent in response to the transaction data, when the determination indicates the proposed cryptocurrency transaction is unverified, indicating that proceeding with the proposed transaction would be unsafe and result in loss of the associated tokens. Additionally, a positive result is sent to the client device or the source cryptocurrency wallet in response to the transaction data, when the determination indicates the proposed cryptocurrency transaction is verified and safe to send.

In yet another example, a verification server is disclosed that includes processor(s) coupled to memory and configured to execute instructions stored in the memory to cause the verification server to receive transaction data for a proposed cryptocurrency transaction. The transaction data includes a destination cryptocurrency wallet type, a blockchain network, and a first token contract address retrieved via a source cryptocurrency wallet. Network data including blockchain network(s) supported by the destination cryptocurrency wallet type and address data comprising a second token contract address for each of one or more tokens supported on each of the blockchain network(s) is obtained. A result is sent in response to the transaction data. The result is generated based on a comparison of portion(s) of the transaction data to the network data and the address data. Specifically, a positive result is sent in response to the transaction data when the comparison of the portion(s) of the transaction data to the network data and the address data indicate that the proposed cryptocurrency transaction is verified and a negative result is sent in response to the transaction data when the comparison of the portion(s) of the transaction data to the network data and the address data indicate that the proposed cryptocurrency transaction is unverified or unsafe and likely to result in loss of the associated tokens.

With this technology, methods, non-transitory computer-readable media, and verification servers are disclosed that advantageously facilitate cryptocurrency transaction pre-verification. A client application (e.g., browser extension) can interface with a source cryptocurrency wallet to obtain transaction data for a proposed cryptocurrency transaction, which is sent to and analyzed by a verification server to determine whether the proposed cryptocurrency transaction is safe or verified. Specifically, the verification server can utilize cryptocurrency wallet APIs and, in real-time or via a generated database, verify the proposed cryptocurrency transaction based on the particular token and blockchain network indicated in the transaction data. Thereby, this technology provides a technical solution that mitigates loss of cryptocurrency tokens within blockchain networks.

### BRIEF DESCRIPTION OF THE DRAWINGS

FIG. 1 is a block diagram of a network environment with an exemplary verification server;

FIG. 2 is a flowchart of an exemplary overall method for cryptocurrency transaction pre-verification across a system including client device, verification server, and third-party data sources;

FIG. 3 is a flowchart of an exemplary method for steering cryptocurrency transaction pre-verification requests initiated at client devices to reduce latency;

FIG. 4 is a flowchart of an exemplary method for leveraging transaction, network, and address data to verify cryptocurrency transactions at a verification server;

FIG. 5 is a flowchart of an exemplary method for data ingestion of third-party Application Programming Interfaces (APIs) to facilitate generation of a verification database;

FIG. 6 shows a screenshot of an exemplary initial user interface;

FIG. 7 shows a screenshot of an exemplary user interface configured to facilitate a user login;

FIG. 8 shows a screenshot of an exemplary user interface configured to facilitate a cryptocurrency account or blockchain address selection by a user;

FIG. 9 shows a screenshot of an exemplary user interface mirroring the assets held in a user's connected cryptocurrency wallet;

FIG. 10 shows a screenshot of an exemplary user interface configured to facilitate selection of a cryptocurrency asset to transfer, an amount to transfer of the selected cryptocurrency asset, a centralized cryptocurrency exchange selection, if applicable to the current proposed transaction, and a destination blockchain address;

FIG. 11 shows a screenshot of an exemplary user interface configured to facilitate user selection of a cryptocurrency asset to transfer, an amount to transfer of the selected cryptocurrency asset, a destination cryptocurrency wallet type associated with a non-custodial cryptocurrency wallet, if applicable to the current proposed transaction, and a destination blockchain address;

FIG. 12 shows a screenshot of an exemplary user interface indicating to a user that a cryptocurrency transaction is being verified before it is conducted;

FIG. 13 shows a screenshot of an exemplary user interface indicating a signature request for a requested cryptocurrency transaction;

FIG. 14 shows a screenshot of an exemplary user interface indicating verification of a proposed cryptocurrency transaction was successful; and

FIG. 15 shows a screenshot of an exemplary user interface indicating verification of a proposed cryptocurrency transaction failed before the cryptocurrency transaction occurred, thereby preventing loss of the cryptocurrency asset(s).

### DETAILED DESCRIPTION

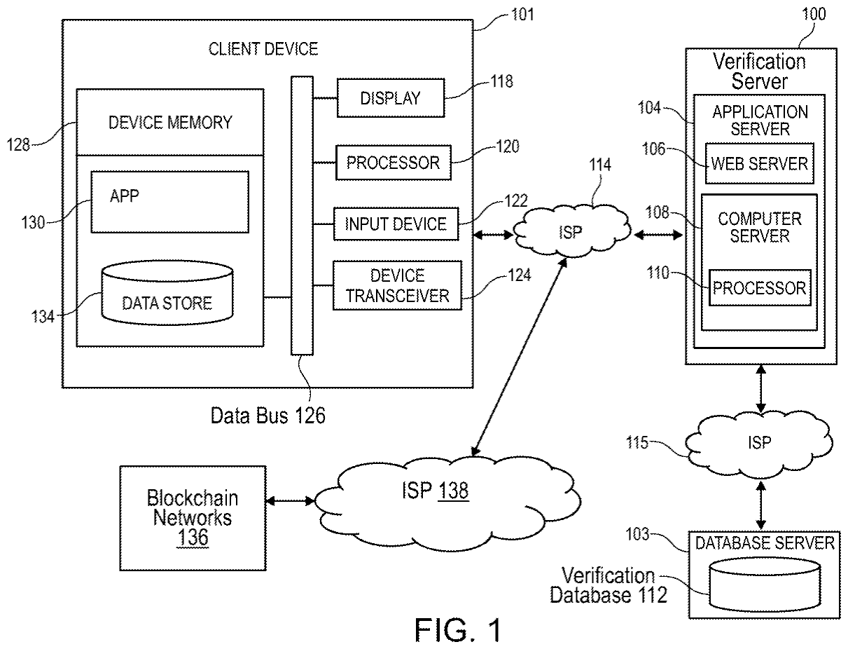

A network environment that may implement one or more aspects of the technology described and illustrated herein is shown in FIG. 1. The network environment in this particular example includes a verification server 100 that is coupled to a client device 101 via an Internet service provider (ISP) 114 (e.g., a wide area network (WAN), local area network (LAN), etc.), blockchain networks 136 via the ISP 114 and another ISP 138, and a database server 103 via yet another ISP 115, although the verification server 100, client device 101, blockchain networks 136, and database server 103 may be coupled together via other topologies in other examples.

While a client-server architecture is shown, other embodiments may use a peer-to-peer architecture, where functionality of the verification server 100 resides in the client device 101. In some examples, the system illustrated in the network environment of FIG. 1 is implemented in multi-tier or n-tier architecture with one or more client devices 101 residing at a client tier, one or more verification servers 100 in the middle or in a server application tier, and one or more database servers 103 residing in a database tier. In the above variant of three-tier architecture the client, the first tier, may have to only perform the user interface i.e., validate inputs; in which case the middle tier holds all the backend logic and does data processing while the data server, the third tier, performs data validation and controls the database access to present content to users.

In this example, users interface with verification server 100 using client devices 101. Multiple client devices 101 may be connected to the verification server 100 via the ISP 114 and can be implemented on any suitable computing platform selected by the user. The verification server 100 communicates with the client devices 101 over the ISP 114 to present a user interface or graphical user interface (GUI). The user interface can be presented through a web browser or through another suitable software application communicating with verification server 100 and is used for displaying, entering, publishing, and/or managing data required for the technology described and illustrated herein. As used herein, the term “ISP” generally refers to any collection of distinct networks working together to appear as a single network to a user. The term also refers to the so-called world wide web, network of networks or Internet which is connected to each other using the Internet protocol (IP) and other similar protocols. As described herein, the ISP 114 is for exemplary purposes only.

Although the description may refer to terms commonly used in describing public networks such as the Internet, the description and concepts equally apply to other public and private computer networks, including systems having architectures dissimilar to that shown in FIG. 1. The disclosed technology is applicable for all existing wireless network topologies or respective communication standards, such as GSM, UMTS/HSPA, 802.11, LTE, 4G, 5G cellular networks and the like.

With respect to the present description, verification server 100 may include any service that relies on a database system that is accessible over an ISP, in which various elements of hardware and software of the database system may be shared by one or more users of the verification server 100. The GUI or user interface dashboard provided by the verification server 100 on client devices 101 through a web browser (e.g., web browser extension) or native application may be utilized for utilizing services hosted by the verification server 100 and includes the screens described and illustrated in more detail below.

The components appearing in the verification server 100 refer to an exemplary combination of those components that would need to be assembled to create the infrastructure to provide the tools and services contemplated by this technology. The verification server 100 can include processor(s) 110, a memory, and a communication interface, which are coupled together by a bus, although the verification server 100 can include other types or numbers of elements in other configurations.

The processor(s) 110 of the verification server 100 may execute programmed instructions stored in the memory of the verification server 100 for any number of the functions identified above. The processor(s) 110 may include one or more central processing units (CPUs) or general-purpose processors with one or more processing cores, for example, although other types of processor(s) can also be used. The memory of the verification server 100 stores these programmed instructions for one or more aspects of the present technology as described and illustrated herein, although some or all of the programmed instructions could be stored elsewhere. A variety of different types of memory storage devices, such as random-access memory (RAM), read only memory (ROM), hard disk, solid state drives, flash memory, or other computer readable medium which is read from and written to by a magnetic, optical, or other reading and writing system that is coupled to the processor(s) 110, can be used for the memory.

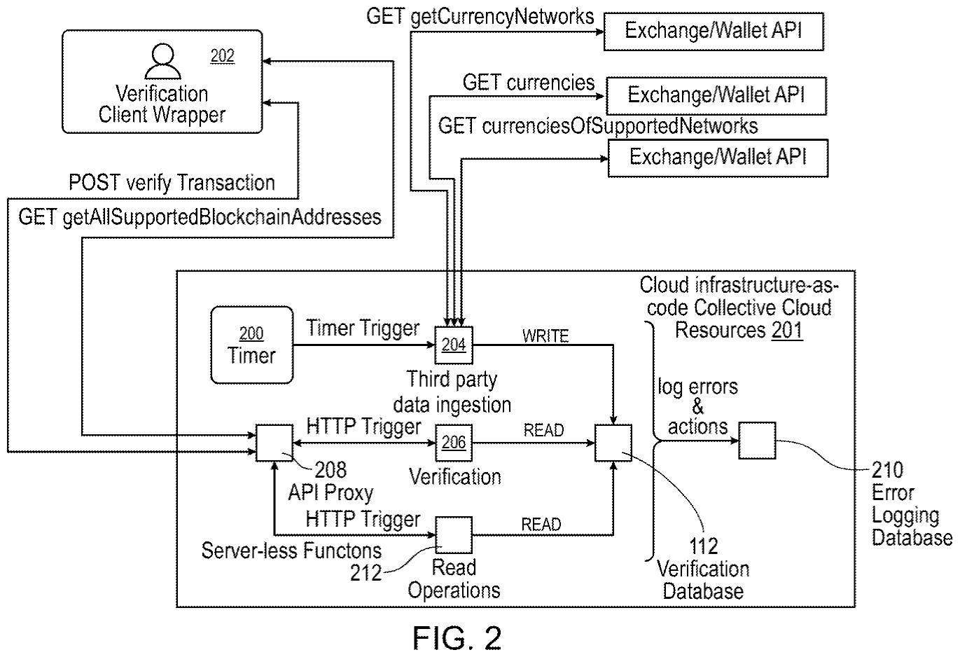

Accordingly, the memory of the verification server 100 can store one or more modules that can include computer executable instructions that, when executed by the verification server 100, cause the verification server 100 to perform actions, such as to transmit, receive, or otherwise process messages, for example, and to perform other actions described and illustrated below with reference to FIGS. 2-5. The modules can be implemented as components of other modules. Further, the modules can be implemented as applications, operating system extensions, plugins, or the like.

Even further, the modules may be operative in a cloud-based computing environment. The modules can be executed within or as virtual machine(s) or virtual server(s) that may be managed in a cloud-based computing environment. Also, the modules, and even the verification server 100 itself, may be in virtual server(s) running in a cloud-based computing environment rather than being tied to one or more specific physical network computing devices. Also, the modules may be running in one or more virtual machines (VMs) executing on the verification server 100. Additionally, in one or more examples of this technology, virtual machine(s) running on the verification server 100 may be managed or supervised by a hypervisor.

The communication interface of the verification server 100 operatively couples and communicates between the verification server 100, servers or other nodes or devices that collectively comprise the blockchain networks 136, database server 103, and client devices 101, which are coupled together at least in part by communication network(s), although other types or numbers of communication networks or systems with other types or numbers of connections or configurations to other devices or elements can also be used.

While the verification server 100 is illustrated in this example as including a single device, the verification server 100 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the verification server 100.

Additionally, one or more of the devices that together comprise the verification server 100 in other examples can be standalone devices or integrated with one or more other devices or apparatuses, such as one or more of the blockchain networks 136 and/or database servers 103, for example. Moreover, one or more of the devices of the verification server 100 in these examples can be in a same or a different communication network including one or more public, private, or cloud networks, for example.

Thus, the technology disclosed herein is not to be construed as being limited to a single environment and other configurations and architectures are also envisaged. For example, one or more of the blockchain networks 136 and/or database servers 103 can operate within the verification server 100 itself rather than as a stand-alone server device communicating with the verification server 100 via communication network(s).

The verification server 100 in this example also includes an application server or executing unit 104. The application server or executing unit 104 includes a web server 106 and a computer server 108 that serves as the application layer of the disclosed technology. The Web server 106 is a system that sends out Web pages containing electronic data files in response to Hypertext Transfer Protocol (HTTP) requests from remote web browsers (e.g., browsers installed in the client devices 101) or in response to similar requests made through a software application installed on a client device 101. The web server 106 can communicate with an application of this technology and/or with a web browser installed on a client device 101 to provide user interfaces, as explained in more detail below.

The computer server 108 may include the processor(s) 110, a RAM for temporary storage of information, and/or a ROM for permanent storage of information. Computer server 108 may be generally controlled and coordinated by operating system software. The operating system controls allocation of system resources and performs tasks such as processing, scheduling, memory management, networking, and I/O services, among other tasks. Thus, the operating system resides in system memory and, on being executed by the processor 110, coordinates the operation of the other elements of the verification server 100.

The database tier is the source of data where at least one database server 103 generally interfaces multiple verification databases 112. As stated above, some or all of verification database 112 may be maintained on a third-party platform, such as Amazon Web Services™ (AWS) or Microsoft Azure™, by way of example only. However, in other examples, the verification database 112 may be integral with the memory of the verification server 100. The verification database 112 is frequently updated by, or through, a combination of private and public networks including ISP 114. While it is described herein that the data is stored in a single database, different separate databases can also store the various data and files of multiple users.

A software application, or “app,” is a computer program executed by the client device 101, which can include a native application downloaded and installed on the client device, a web browser extension, a WebApp accessed by a web browser that does not require any software download or extension, or executable code embedded within another software application (e.g., a source cryptocurrency wallet application), for example, and other methods for executing aspects of this technology implemented by the client device 101 can also be used in other examples. App 130, custom built for the present technology, enables one or more persons to do various tasks related to implementing portion(s) of the technology described and illustrated herein. The activities related to this technology can also be performed using the user interface (or GUI) presented through a client device-based web browser. Hereinafter, the term “user interface” is used to refer to both app user interfaces and web browser user interfaces. Examples of client device 101 may include, but not limited to, mobile devices, tablets, hand-held or laptop devices, smart phones, personal digital assistants, desktop computers, wearable devices, augmented reality glasses, virtual reality headsets, or any similar device.

As illustrated in FIG. 1, the client device 101 may include a device display 118, a computer processor 120, a user input device 122 (e.g., touch screen, keyboard, microphone, and/or other form of input device known in the art), a device transceiver 124 for communication, a device memory 128, the app 130, a local data store 134 also installed in the device memory 128, and a data bus 126 interconnecting the aforementioned components. For purposes of this application, the term “transceiver” is defined to include any form of transmitter and/or receiver known in the art, for cellular, WIFI, radio, and/or other form of wireless or wired communication known in the art.

Although the exemplary system with the verification server 100, blockchain networks 136, client devices 101, database servers 103, and communication network(s) are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the system, such as the verification server 100, blockchain networks 136, client devices 101, or database servers 103, for example, may be configured to operate as virtual instances on the same physical machine. In other words, one or more of the verification servers 100, blockchain networks 136, client devices 101, or database servers 103 may operate on the same physical device rather than as separate devices communicating through communication network(s). Additionally, there may be more or fewer verification servers 100, blockchain networks 136, client devices 101, or database servers 103 than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks, Packet Data Networks (PDNs), the Internet, intranets, and combinations thereof.

The examples may also be embodied as one or more non-transitory computer readable media having instructions stored thereon, such as in the memory of the verification server 100, for one or more aspects of the present technology, as described and illustrated by way of the examples herein. The instructions in some examples include executable code that, when executed by one or more processors, such as the processor(s) 110 of the verification server 100, cause the processors to carry out steps necessary to implement the methods of the examples of this technology that are described and illustrated herein.

Referring more specifically to FIG. 2, a flowchart of an exemplary overall method for cryptocurrency transaction pre-verification across a system including client device 101, verification server 100, and third-party data sources is illustrated. The exemplary verification cloud infrastructure-as-code collective cloud resources 201 view illustrated in FIG. 2 shows a high-level representation of server-side infrastructure and how each component interacts. The cloud infrastructure-as-code collective cloud resources 201 implementation is illustrated in FIG. 2 by way of example only and any other bundle of resources or deployment type can also be used in other examples.

FIG. 2 reads from left to right and has two starting points, the timer 200 and the client wrapper 202. The timer 200 flow represents the process of fetching relevant verification data, including network data (e.g., list of supported blockchain networks) and address data (e.g., list of supported token contract addresses on the particular blockchain networks identified in the network data), from exemplary third-party data sources (e.g., via APIs) and storing it within the verification database (e.g., verification database 112). In particular, the verification server 100 in this example performs third party data ingestion 204 (e.g., from centralized cryptocurrency exchanges or other entities associated with non-custodial cryptocurrency wallets) to obtain the cryptocurrency networks and cryptocurrencies supported by those centralized cryptocurrency exchanges and entities associated with non-custodial cryptocurrency wallets. The third-party data ingestion 204 can be performed via exchange or wallet APIs, or any other integration method, and the obtained network and address data is then used by the verification server 100 to populate and update the verification database (e.g., verification database 112).

The client wrapper 202 flow starts with the client wrapper 202 and represents the process of client device 101 consumption (e.g., of an output or result from the verification server 100). The client device 101, through app 130 effectively gets access to the verification database 112 via the API proxy 208 verification server 100 in order to deliver appropriate responses. Specifically, the getAllSupportedBlockchainAddresses call to the API proxy 208 initiate the server-less functions 212 to fetch a list of the supported centralized cryptocurrency exchanges and/or entities associated with non-custodial cryptocurrency wallets to facilitate a selection by a user of the client device 101. The verify Transaction process initiates a call to the API proxy 208 with transaction data passed to the verification server 100 after client selections and other inputs via the client device 101 and initiates the verification process 206 to apply multiple verification steps to the received transaction data, and subsequently provide verification results, as described and illustrated in more detail below. Any errors in this process can be logged in the error logging database 210.

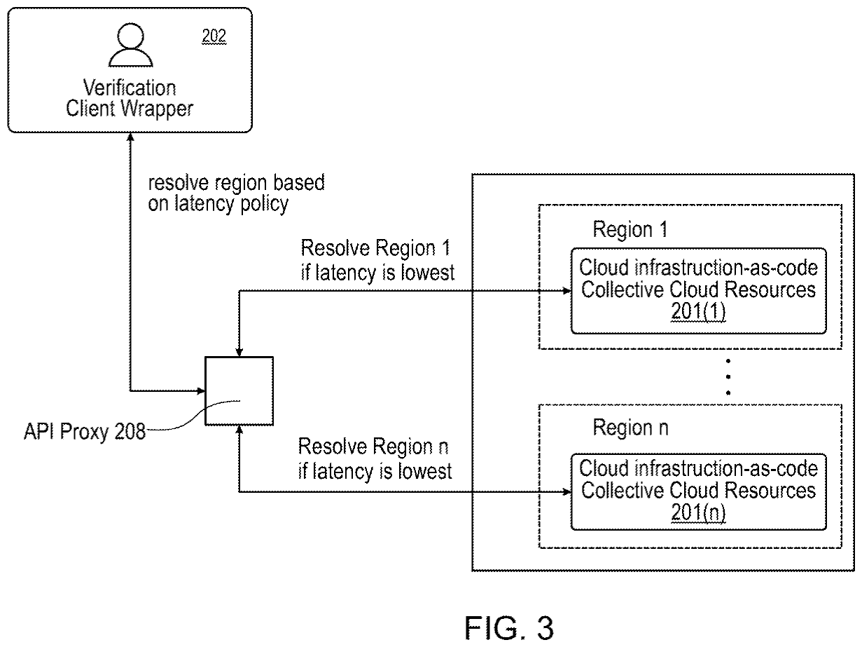

Referring to FIG. 3, a flowchart of an exemplary method for steering cryptocurrency transaction pre-verification requests initiated at client devices 101 to reduce latency is illustrated. The routing view of FIG. 3 shows a high-level representation of how traffic is routed to the verification server 100 infrastructure. The diagram reads from left to right with its only starting point being client wrapper 202. The verification cloud infrastructure-as-code collective cloud resources 201(1)-201(n) are deployed in separate pre-configured regions such as Region 1 (e.g., for the western US) and Region n (e.g., for the eastern US), although any number of regions can be used.

The API proxy 208 determines which region has the shortest latency to the client device 101, then resolves the appropriate one of the verification cloud infrastructure-as-code collective cloud resources 201(1)-201(n) and directs traffic (e.g., a cryptocurrency transaction pre-verification request) to the selected one of the verification cloud infrastructure-as-code collective cloud resources 201(1)-201(n). This design provides both redundancy and load balancing as well as a better user experience.

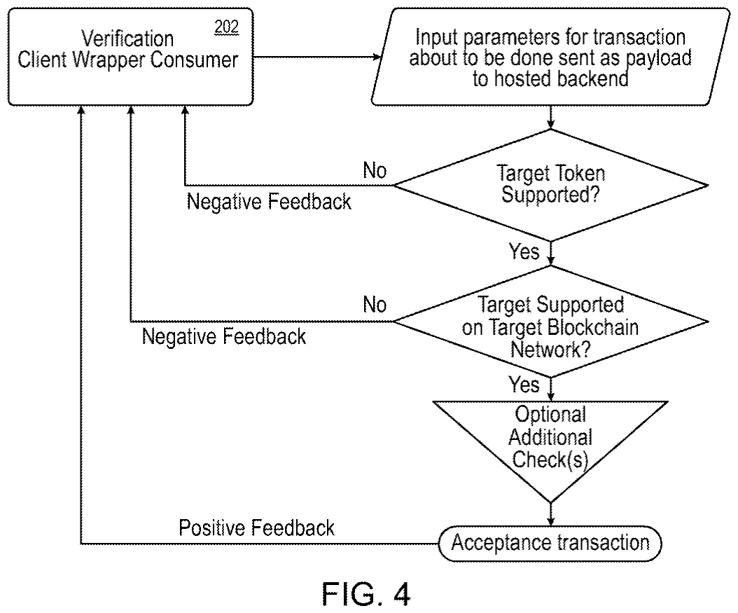

Referring to FIG. 4, a flowchart of an exemplary method for leveraging transaction, network, and address data to verify cryptocurrency transactions at the verification server 100 is illustrated. The flowchart of FIG. 4 shows a more detailed representation of the verification process, which starts with client wrapper 202 sending a data payload, for example, which includes transaction data representing a proposed cryptocurrency transaction about to be sent. The app 130 in some examples can interface with a source cryptocurrency wallet executed by the client device 101 to intercept or otherwise obtain the transaction data, although the transaction data can also be obtained in other ways in other examples.

The transaction data in some examples includes one or more of a source wallet address of the source cryptocurrency wallet (e.g., “0x . . . ”), a target or destination wallet address of the intended destination or recipient cryptocurrency wallet (e.g. “0x . . . ”), a destination cryptocurrency wallet type (e.g., a centralized cryptocurrency exchange custodial cryptocurrency wallet, such as a Binance exchange or Coinbase exchange wallet, or a non-custodial cryptocurrency wallet, such as a MetaMask, Ledger, Opera Wallet, or TrustWallet cryptocurrency wallet), a token contract address (e.g., an address on a blockchain network for “MATIC,” “ETH,” “BNB,” “USDC,” or another cryptocurrency coin/token/non-fungible token, etc.), and/or a target network, which is the intended transaction blockchain network (e.g., “POLYGON”).

Optionally, an initial validation check is performed by the verification server 100 to determine whether the destination wallet address and/or token contract address is compliant with a format consistent with Ethereum Virtual Machine (EVM) compatible cryptocurrency wallets, although other cryptocurrency wallet format checks can also be performed by the verification server 100. Also optionally, the verification server 100 can perform an initial verification check based on a comparison of the destination wallet address and/or token contract address to a blacklist of known malicious or nefarious destination wallet addresses and/or token contract addresses, and other preliminary verification checks can also be performed in other examples.

The verification server 100 then uses the transaction data to validate against network data and address data previously acquired (e.g., via centralized cryptocurrency exchange APIs or APIs hosted by other entities associated with non-custodial cryptocurrency wallets, as explained above with reference to FIG. 2). In other examples, the network data and address data can be obtained in real-time responsive to the cryptocurrency transaction verification request and/or transaction data. In this particular example, the verification server 100 then proceeds to validate that the token contract address in the transaction data is supported by the destination cryptocurrency wallet type identified in the transaction data based on a comparison of portions of the transaction data to the obtained network data and the address data.

If the verification server 100 determines that the token contract address reflects a target token supported by the indicated destination cryptocurrency wallet type, then the Yes branch is taken and the verification server 100 then validates that the token contract address is supported by the destination cryptocurrency wallet type on the particular target blockchain network 136 identified in the transaction data based on a comparison of those portions of the transaction data to the previously-obtained network data and the address data.

If any of the verification steps fail, a negative result is returned to the client device 101 by the verification server 100 and the transaction is automatically cancelled (i.e., restricted from being proposed or otherwise not initiated to the blockchain network 136) via an interface with the cryptocurrency wallet on the client device 101 or an interface is generated providing a user of the client device 101 with an opportunity to cancel the cryptocurrency transaction. Thereby, the user is prevented from losing cryptocurrency by sending it to an incompatible wallet and/or exchange and/or by using an unsupported coin, for example.

However, if all the verification steps succeed, then the client device 101 is presented with a positive result and the transaction can be accepted by a user via an interface provided within the source cryptocurrency wallet on the client device 101. Optionally, before this verification process starts, the user of the client device 101 is prompted to approve/pay a fee. The fee is paid in the native cryptocurrency of the blockchain network on which the user is attempting to engage in a transaction, for example, although other types of payments, and/or payment methods, can also be used in other examples.

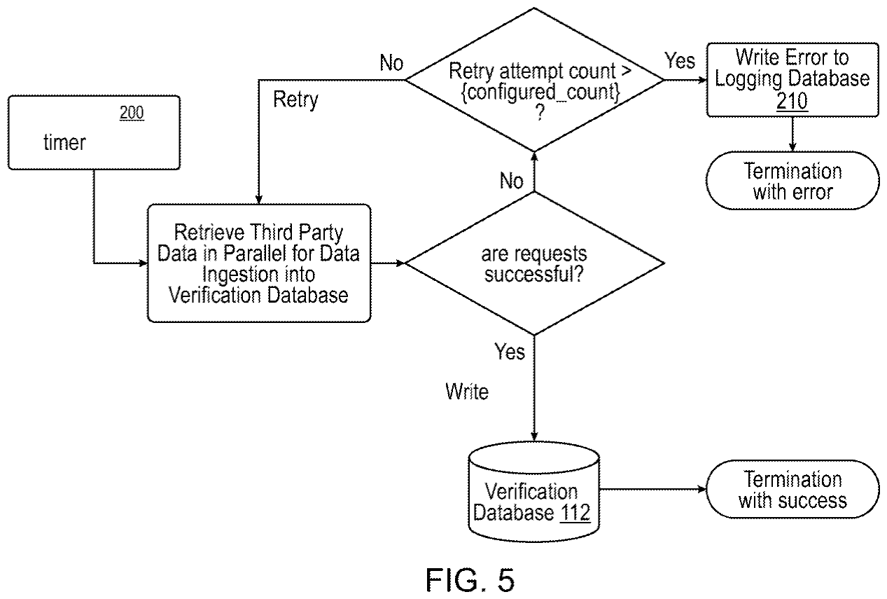

Referring now to FIG. 5, a flowchart of an exemplary method for data ingestion using third-party APIs to facilitate generation of the verification database 112 is illustrated. The data ingestion flowchart of FIG. 5 shows a more detailed representation of the process which reaches out to entities (e.g., centralized cryptocurrency exchanges and/or entities associated with non-custodial cryptocurrency wallets) to populate the verification database 112 with supported network and address data. While data ingestion can be used along with the generated verification database 112, in other examples the network and address data can be obtained in real-time responsive to a verification request or transaction data from the client device 101, as explained above.

In this example, the verification server 100 stores a timer 200, which is set for a periodic interval (e.g., five or ten minutes) and which triggers the verification server 100 to obtain the network data (e.g., list of supported blockchain networks) and address data (e.g., list of supported token contract addresses on the particular blockchain networks identified in the network data) from a plurality of entities (e.g., centralized cryptocurrency exchanges and/or entities associated with non-custodial cryptocurrency wallets) using provided APIs, optionally in parallel. In the event of an error or a timeout during the fetching process of any of the APIs, the request is retried up to a pre-configured maximum number of attempts, after which the error is logged to facilitate debugging. However, if the requests are successful, the data for each entity is then standardized into a predetermined optimized format and stored in the verification database 112. While a timer 200 mechanism is used in this example, any other trigger and/or type of data ingestion (e.g., batching or streaming) can also be used in other examples.

Some entities (e.g., centralized cryptocurrency exchanges and/or entities associated with non-custodial cryptocurrency wallets) specify the tokens they accept but do not indicate the blockchain network on which they accept each of the particular tokens. The verification database 112 in some examples is generated by the verification server 100 to include an indication of the tokens that are accepted on particular blockchain networks, optionally indexed by entity, whereby each entity can be correlated with a destination cryptocurrency wallet type (e.g., a Binance wallet type is associated with the Binance centralized cryptocurrency exchange and a MetaMask wallet is associated with the Metamask entity). Thus, the obtained network and address data is optionally parsed and analyzed to index the supported blockchain networks and token contract addresses for each of the entities. For example, a first centralized cryptocurrency exchange may not make token contract addresses available via API, but does provide another indication of the supported tokens, in which case the token contract addresses for those tokens as retrieved from another API associated with a second centralized cryptocurrency exchange can be stored and correlated with the first centralized cryptocurrency exchange in the verification database 112.

Additionally, some tokens have a contract address on one blockchain network, but a different contract address on another blockchain network (e.g., the token contract address for USDC on Polygon is different than the token contract address for USDC on ETH). If a centralized cryptocurrency exchange states that it accepts a type of cryptocurrency and provides the associated token contract address in response to the API call, then verification server 100 can cross-reference the token contract addresses with blockchain networks provided by other entities in response to other API calls and can thereby determine what blockchain network(s) support a particular token.

In other examples, the network and/or address data for one or more of the entities can be provided by manually testing transactions executed against destination wallets associated with the entities. In yet other examples, one or more entities may provide a public or a private API or other database or datastore access to facilitate population of the verification database 112. Other methods for processing the centralized cryptocurrency exchange network and address data to generate the verification database 112 can also be used in other examples.

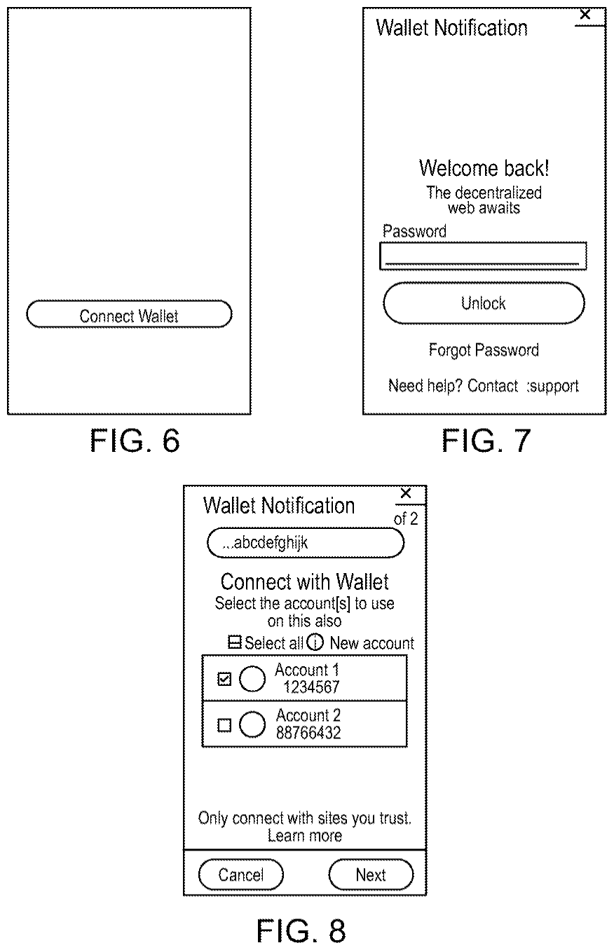

Referring to FIG. 6, an exemplary verification process according to the technology described and illustrated herein begins with a user of the client device 101 selecting a downloaded or installed extension or other app 130 to connect directly to the source cryptocurrency wallet (e.g., a non-custodial MetaMask cryptocurrency wallet), optionally in a read-only manner. After potentially entering a password, or by any other determined means of login to the source wallet that a user chooses to connect with, into interface screen of FIG. 7 and selecting an account (i.e., a cryptocurrency wallet address) having an associated blockchain network on interface screen of FIG. 8, in this particular example in which a MetaMask cryptocurrency wallet is used, the user optionally selects “Approve Transaction” to facilitate a fee payment to the verification service provider for the ability for the app 130 to have read-only access to the source cryptocurrency wallet.

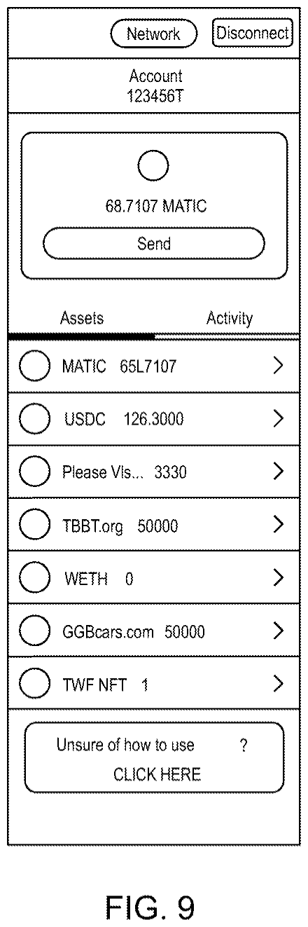

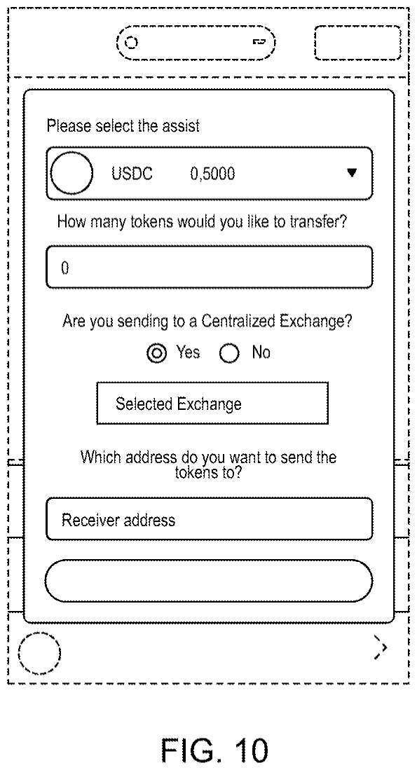

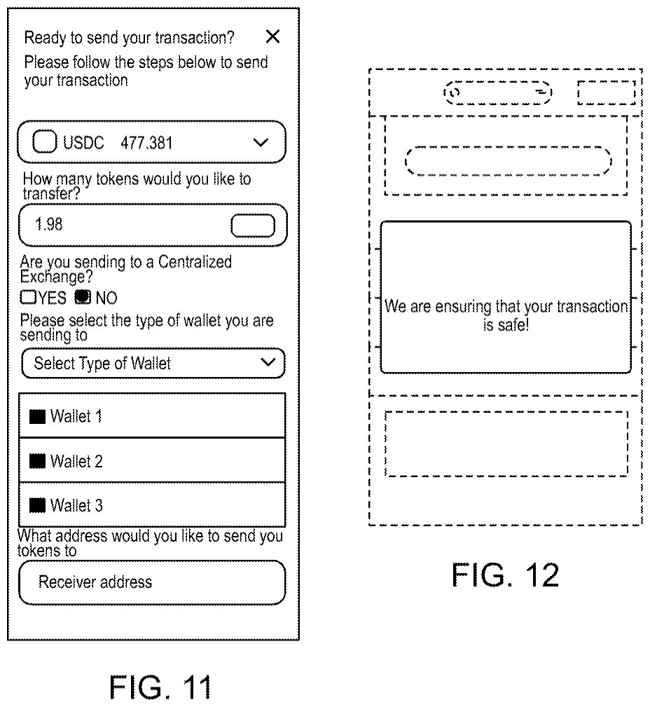

On the interface screen of FIG. 9, the user selects the token/coin/crypto/currency/cryptocurrency (commonly referred to herein as a token) to be sent on the blockchain network from the assets associated with the selected account and mirrored from the user's cryptocurrency wallet, and this selection is shown on the interface screen of FIG. 10 and/or FIG. 11. The user selects the amount of the cryptocurrency token to transfer on the blockchain network on the interface screen of FIG. 10 and/or FIG. 11. The user then selects the destination cryptocurrency wallet address type, which can be a centralized cryptocurrency exchange, such as the Coinbase.com Exchange illustrated in FIG. 10. In another example illustrated in FIG. 11, the user indicates that the indicated amount of the cryptocurrency token is not to be sent on a centralized cryptocurrency exchange, in which case a dropdown menu is provided to facilitate selection of a destination cryptocurrency wallet address type associated with a non-custodial cryptocurrency wallet, such as Ledger in the example illustrated in FIG. 11

After entry of the destination cryptocurrency wallet address type via the user interface of FIG. 10 or FIG. 11, the user then specifies a recipient or destination cryptocurrency wallet address to which the cryptocurrency token is to be sent. The user is then optionally prompted to pay a transaction fee before the transaction data, including the destination cryptocurrency wallet address type, blockchain network, and token contract address (e.g., as determined by the source cryptocurrency wallet and corresponding to the selected cryptocurrency token), is transmitted to the verification server 100. The verification server 100 then performs the verification checks as described and illustrated in detail above. The interface screen of FIG. 12 indicates to the user of the client device 101 that a check is performed before the transaction hits the blockchain network or is available for approval/confirmation in the source cryptocurrency wallet.

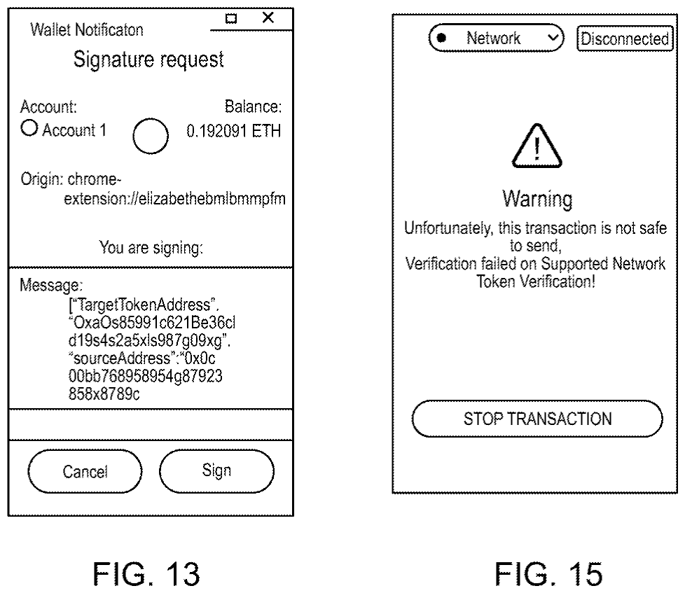

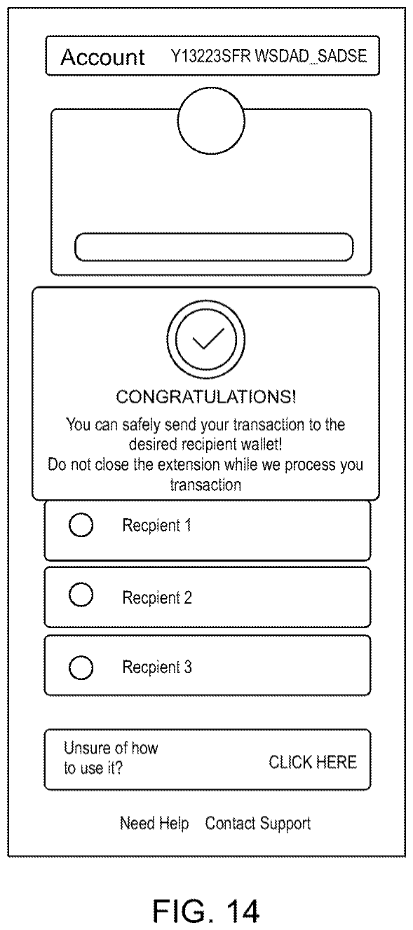

The interface screen of FIG. 13 is provided to the user to obtain the user's signature or other approval for the verification process to proceed. The interface screen of FIG. 14 is then provided to the user via the client device 101 to indicate that the verification was successful in examples in which the result from the verification server 100 is positive. In another example in which the result from the verification server 100 is negative, the interface screen of FIG. 15 is displayed, which indicates that the transaction is not safe, and the user has the option to halt the transaction or return to the source wallet to manually initiate the transaction effectively, overriding the negative verification result.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method of cryptocurrency transaction pre-verification, the method implemented by a verification server and comprising:
receiving from a client device transaction data for a proposed cryptocurrency transaction, wherein the transaction data comprises a destination cryptocurrency wallet type, a blockchain network, and a first token contract address retrieved via a source cryptocurrency wallet at the client device;
obtaining network data comprising one or more blockchain networks supported by the destination cryptocurrency wallet type and address data comprising a second token contract address for each of one or more tokens supported on each of the one or more blockchain networks;
determining whether the proposed cryptocurrency transaction is verified based on a comparison of one or more portions of the transaction data to the network data and the address data; and
sending a positive result to the client device or the source cryptocurrency wallet in response to the transaction data, when the determination indicates the proposed cryptocurrency transaction is verified.

2. The method of claim 1, further comprising retrieving one or more of the network data or the address data via an application programing interface (API) provided by an entity associated with the destination cryptocurrency wallet type.

3. The method of claim 1, wherein the destination cryptocurrency wallet type comprises a centralized cryptocurrency exchange or another type of custodial cryptocurrency wallet.

4. The method of claim 1, wherein the destination cryptocurrency wallet type comprises a non-custodial wallet.

5. The method of claim 2, further comprising retrieving the one or more of the network data or the address data after receiving the transaction data from the client device to facilitate the comparison.

6. The method of claim 2, further comprising:
retrieving the one or more of the network data or the address data prior to receiving the transaction data from the client device;
populating a database with the network data and the address data; and
obtaining the network data and the address data from the database subsequent to receiving the transaction data from the client device to facilitate the comparison.

7. The method of claim 1, further comprising:
obtaining other network data comprising another one or more blockchain networks supported by each of a plurality of destination cryptocurrency wallet types via a plurality of application programing interfaces (APIs) provided by a plurality of entities associated with the destination cryptocurrency wallet types; and
populating a database with the other network data.

8. The method of claim 7, further comprising:
obtaining other address data comprising a third token contract address for each of another one or more tokens supported on each of the other one or more blockchain networks supported by each of a subset of the destination cryptocurrency wallet types; and
populating the database with the other address data.

9. The method of claim 8, further comprising:
obtaining token data comprising a list of one or more tokens accepted by each of the other one or more blockchain networks for one of the destination cryptocurrency wallet types via one of the APIs;
correlating the token data with the other address data to identify the third token contract address for each of the one or more tokens; and
populating the database based on the correlation.

10. The method of claim 1, further comprising sending a negative result to the client device or the source cryptocurrency wallet in response to the transaction data, when the determination indicates the proposed cryptocurrency transaction is unverified.

11. A non-transitory computer-readable medium comprising instructions for cryptocurrency transaction pre-verification comprising executable code that, when executed by one or more processors, causes the one or more processors to:
populate a database with network data and address data provided by an entity associated with a destination cryptocurrency wallet type, wherein the network data comprises one or more blockchain networks supported by the destination cryptocurrency wallet type and the address data comprises a first token contract address for each of one or more tokens supported on each of the one or more blockchain networks;
receive transaction data for a proposed cryptocurrency transaction, wherein the transaction data comprises the destination cryptocurrency wallet type, a blockchain network, and a second token contract address;
obtain the network data and the address data from the database using the destination cryptocurrency wallet type;
determine whether the proposed cryptocurrency transaction is verified based on a comparison of the blockchain network to the one or more blockchain networks in the network data and the second token contract address to the first token contract address; and
send a negative result to a client device or a source cryptocurrency wallet in response to the transaction data, when the determination indicates the proposed cryptocurrency transaction is unverified.

12. The non-transitory computer-readable medium of claim 11, wherein the destination cryptocurrency wallet type comprises a centralized cryptocurrency exchange, another type of custodial cryptocurrency wallet, or a non-custodial wallet and the executable code, when executed by the one or more processors, further causes the one or more processors to send a positive result in response to the transaction data, when the determination indicates the proposed cryptocurrency transaction is verified.

13. The non-transitory computer-readable medium of claim 11, wherein the executable code, when executed by the one or more processors, further causes the one or more processors to retrieve the network data and the address data via an application programing interface (API) provided by the entity, wherein the destination cryptocurrency wallet type comprises a centralized cryptocurrency exchange, another type of custodial cryptocurrency wallet, or a non-custodial wallet.

14. A verification server, comprising one or more processors coupled to memory and configured to execute instructions stored in the memory to cause the verification server to:
receive transaction data for a proposed cryptocurrency transaction, wherein the transaction data comprises a destination cryptocurrency wallet type, a blockchain network, and a first token contract address retrieved via a source cryptocurrency wallet;
obtain network data comprising one or more blockchain networks supported by the destination cryptocurrency wallet type and address data comprising a second token contract address for each of one or more tokens supported on each of the one or more blockchain networks; and
send a result in response to the transaction data, wherein the result is generated based on a comparison of one or more portions of the transaction data to the network data and the address data.

15. The verification server of claim 14, wherein the one or more processors are further configured to execute the stored instructions to cause the verification server to:
retrieve one or more of the network data or the address data prior to receiving the transaction data;
populate a database with the network data and the address data; and
obtain the network data and the address data from the database after receiving the transaction data to facilitate the comparison.

16. The verification server of claim 14, wherein the one or more processors are further configured to execute the stored instructions to cause the verification server to:
obtain other network data comprising another one or more blockchain networks supported by each of a plurality of destination cryptocurrency wallet types via a plurality of application programing interfaces (APIs) provided by a plurality of entities associated with the destination cryptocurrency wallet types; and
populate a database with the other network data.

17. The verification server of claim 16, wherein the one or more processors are further configured to execute the stored instructions to cause the verification server to:
obtain other address data comprising a third token contract address for each of another one or more tokens supported on each of the other one or more blockchain networks supported by each of a subset of the destination cryptocurrency wallet types; and
populate the database with the other address data.

18. The verification server of claim 17, wherein the one or more processors are further configured to execute the stored instructions to cause the verification server to:
obtain token data comprising a list of one or more tokens accepted by each of the other one or more blockchain networks for one of the destination cryptocurrency wallet types via one of the APIs;
correlate the token data with the other address data to identify the third token contract address for each of the one or more tokens; and
populate the database based on the correlation.
